(19) United States
(12) Patent Application Publication
(10) Pub. No.: US 2018/0101826 A1
(43) Pub. Date: Apr. 12, 2018

(54) LUMINAIRE-BASED MONITORING

(71) Applicant: PHILIPS LIGHTING HOLDING B.V., EINDHOVEN (NL)

(72) Inventors: MARTIJN MARIUS HULTERMANS, EINDHOVEN (NL); EDITH DANIELLE DEN HARTOG, EINDHOVEN (NL); MAURICE ALEXANDER HUGO DONNERS, EINDHOVEN (NL); OSCAR HENDRIKUS WILLEMSEN, EINDHOVEN (NL)

(73) Assignee: PHILIPS LIGHTING HOLDING B.V., EINDHOVEN (NL)

(21) Appl. No.: 15/567,105

(22) PCT Filed: Apr. 18, 2016
(86) PCT No.: PCT/EP2016/058560

§ 371 Date: Oct. 17, 2017

(30) Foreign Application Priority Data
Apr. 30, 2015 (EP) 15165889.5

(51) Int. Cl. G06Q 10/00; H05B 33/08

(52) U.S. Cl. CPC G06Q 10/20; H05B 33/0854

(57) ABSTRACT

A signal is received at a monitoring device from a photodetector. The signal conveys a characteristic of radiation received by the photodetector from an exit piece of a luminaire, through which exit piece light emitted by the luminaire exits the luminaire. Based on the characteristic, the monitoring device is used to determine a dirt level on the exit piece. A geographic location associated with the luminaire is identified based on a geographic proximity of the geographic location to the luminaire. In response to an increase in the determined dirt level, the monitoring device generates a control signal which causes an object at the geographic location that is separate from the luminaire to be cleaned.

### TECHNICAL FIELD

This disclose is in the field of luminaires, and particular uses thereof.

### BACKGROUND

A luminaire (lighting fixture) is an electrical device that supports and provides power to an electrical light source (lamp) so as to provide artificial illumination. A typical luminaire has a socket, which holds the lamp in place. Usually the lamp is replaceable. The lamp emits light which the luminaire may be arranged to manipulate, for example to focus or otherwise direct it. The luminaire may comprise a casing that houses the lamp, at least a part of which (exit piece) is formed of transparent or partially transparent, i.e. non-opaque, intended to allow the emitted light to exit the casing. A luminaire has a light output, which is the power of the light which does manage to exit the luminaire in this manner. A luminaire may be configured for installation indoors, outdoors or either as desired. The luminaire itself may be supported by a pole, ceiling, wall etc.

Outdoor lighting infrastructure typically is persistent for relatively long periods of time; for example the same light pole might be in a street for more than 25 years (sometimes even 50 years). In case of conventional lighting regular maintenance is required, the light sources themselves will not last this long and will break down and will need to be replaced. Typically during replacement of lamps a technician, for example acting on behalf of a maintenance company, will also clean the fixture. Sometimes ‘mass replacement’ is performed, i.e. when all luminaires in a specific area are close to their expected ‘end-of-life’ and are replaced in one go, each being replaced with a new, clean luminaire. The cleaning of outdoor luminaires in general is a side-effect of other maintenance activities that are performed. That is, maintenance parties do not perform cleaning only, it is only performed with any other maintenance activities.

### SUMMARY

In a first aspect a method comprises:

at a monitoring device, receiving from a photodetector a signal that conveys a characteristic of radiation received by the photodetector from an exit piece of a luminaire, through which exit piece light emitted by the luminaire exits the luminaire;

based on the characteristic, using the monitoring device to determine a dirt level on the exit piece;

identifying a geographic location associated with the luminaire based on a geographic proximity of the geographic location to the luminaire; and

in response to an increase in the determined dirt level, the monitoring device generating a control signal which causes an object at the geographic location that is separate from the luminaire to be cleaned.

The exit piece becomes increasingly opaque to light over time as the dirt level on it increases, due to gradual deposition of e.g. soil, dust, pollutants etc. This reduction is detectable by the photodetector as it affects the characteristic (e.g. power level) of the radiation. Thus the dirt level on the exit piece is detectable from the detector signal. The luminaire has an output power, i.e. the power of the light which is transmitted through the exit piece as opposed to that reflected back from it, which decreases as more dirt is deposited on the exit piece, thereby degrading the performance of the luminaire. Thus the dirt level provides information about how well the luminaire is performing.

The inventors have recognized that the dirt level on the exit piece of the luminaire can also be used to infer information about dirt levels on other objects—for example buildings, pieces of furniture, e.g. city furniture such as an outdoor bench, pieces of city infrastructure etc. —proximate to, i.e. in the vicinity of, of the luminaire i.e. objects near enough to the luminaire that their own dirt levels are correlated with the dirt level on the exit piece of the luminaire. Thus as the dirt level on the exit piece is observed to increase, it can be inferred that the dirt level on such an object is also increasing, thereby prompting the cleaning of this object when the dirt level on the exit piece of luminaire exceeds an acceptable limit. Where this acceptable limit lies is context dependent, and may depend on factors such as a type of the object, the nature of its environment, and/or any obligations imposed on an entity responsible for its cleaning etc.

In some cases, at least the exit piece of the luminaire may also be cleaned in response to said increase i.e. when the object is cleaned. In other cases, the exit piece may not be cleaned in response to said increase i.e. it may intentionally not be cleaned when the object is cleaned should this be deemed unnecessary. That is, the dirt level on the exit piece may on occasions be used as indicator that, say, a near-by outdoor bench or other object may need cleaning even though the dirt level is not high enough to warrant cleaning the luminaire itself at that point; the exit piece itself may for instance only be cleaned in response to a further increase in the indicated dirt level. On the other hand, even the further increase may not warrant cleaning the luminaire, but it may nonetheless warrant re-cleaning of the object and/or cleaning of another such object. In other words, in response to a further increase in the indicated dirt level, the method may comprise cleaning: the object again and/or another such object at another such location and/or at least the exit piece of the luminaire.

In embodiments, the control signal may be generated in response to the monitoring device detecting that the dirt level on the luminaire has reached a first threshold, and the method may also comprise: in response to the monitoring device detecting that the dirt level on the luminaire has subsequently reached a second threshold higher than the first threshold, the monitoring device generating another control signal which causes the object to be cleaned again.

Alternatively or in addition, the method may comprise the monitoring device: computing a dirt level on the object based on the dirt level on the luminaire; and in response to the increase in the determined dirt level on the luminaire, increasing the computed dirt level on the object. The control signal may cause the monitoring device to: output an indicator of the increased dirt level on the object so as to cause said cleaning, and then reset the computed dirt level on the object without resetting the dirt level on the luminaire.

As indicated, the characteristic conveyed by the signal may be a power level of the radiation. For instance, the radiation may be light which has been emitted by the luminaire, e.g. in fulfilling its primary illumination function, and directed from the output piece onto the photodetector. Preferably, the radiation is light which has been emitted by the luminaire and reflected from the output piece onto the photodetector, whereby the indicated dirt level increases as the power level of the reflected light increases. For example, the photodetector may be housed within a casing of the luminaire, with the lamp also housed in the same casing and the exit piece forming part of the casing. Nevertheless, the possibility of the photodetector receiving light transmitted through the casing is not excluded, nor is the possibility of using other radiation e.g. from a separate dedicated radiation (e.g. visible light, infrared etc.) source.

An indicator of the dirt level may be outputted from the monitoring device, and the control signal may cause the indicator to convey the increase in the dirt level. For example, the indicator may be outputted in response to the control signal or the indicator may be outputted beforehand and the control signal may cause a change in the outputted indicator (for example, a color change of a visual indicator).

The indicator of the dirt level may comprise a reflectance and/or a transmittance of the exit piece and/or a verbal description of the dirt level.

Additionally or alternatively, the indicator of the dirt level may be a visual indicator that is outputted via a display device. For example, the visual indicator may be outputted on a map displayed on the display device, whereby the visual indicator indicates: the dirt level on the exit piece and the geographic location of the luminaire on the map and/or the geographic location of the object on the map.

As another example, alternatively or in addition, the dirt level may be indicated by a color, tint, tone, shading, and/or shape of the visual indicator.

The output device may comprise a processor and the indicator may be generated and outputted by code executed on the processor.

The monitoring device may access in computer storage information about the object, the information describing at least one characteristic of the object and/or its environment, and the control signal may be generated based on the accessed information.

In a second aspect a computer program product comprises code stored on a computer readable storage medium and configured when executed to perform operations of:

receiving from a photodetector a signal that conveys a characteristic of radiation received by the photodetector from an exit piece of a luminaire, through which exit piece light emitted by the luminaire exits the luminaire;

based on the characteristic, determining a dirt level on the exit piece;

accessing geographic proximity data pertaining to the luminaire in computer storage;

using the accessed data to identify at least one geographic location associated with the luminaire, other than that of the luminaire, and/or an object separate from the luminaire (for example, an object at such a location); and

outputting a set of one or more indicators, the outputted set indicating the dirt level and the at least one location and/or the object.

In embodiments, the set may comprise a visual indicator that is outputted on a map via a display device and indicates the at least one location on the map.

For example, the at least one location is one of a set of locations that constitutes an area, and the visual indicator may delineate the area on the map.

As another example, alternatively or in addition, the luminaire may be one of multiple luminaires. For each luminaire a respective signal may be received from a respective photodetector, wherein the respective signal conveys a respective characteristic of radiation received by the respective photodetector from an exit piece of that luminaire. A respective dirt level on the exit piece of each luminaires may be determined, and the operations may comprise:

for at least another of the luminaires:

determining a difference between the dirt level of the luminaire and the dirt level of the other luminaire;

determining whether the difference exceeds a first amount;

determining a geographic separation between the luminaire and the other luminaire based on the geographic proximity data;

determining whether the geographic separation exceeds a second amount; and

if the difference does not exceed the first amount and the geographic separation does not exceed the second amount: determining an area associated with the luminaire and the other luminaire, the area including the at least one geographic location, and indicating the area on the displayed map.

In a third aspect a monitoring device comprises:

an output apparatus;

an input configured to receive from a photodetector a signal that conveys a characteristic of radiation received by the photodetector from an exit piece of a luminaire, through which exit piece light emitted by the luminaire exits the luminaire;

a processor configured to perform operations of:

based on the characteristic, determining a dirt level on the exit piece;

accessing geographic proximity data pertaining to the luminaire in computer storage;

using the accessed data to identify at least one geographic location associated with the luminaire, other than that of the luminaire, and/or an object separate from the luminaire (for example an object at such a location); and

outputting a set of one or more indicators, the outputted set indicating the dirt level and the at least one geographic location and/or the object.

In a fourth aspect, a system comprises: a luminaire; a photodetector located to receive radiation from an exit piece of the luminaire, through which exit piece light emitted by the luminaire exits the luminaire; and a monitoring device according to the third aspect connected to the sensor.

In a fourth aspect a method comprises:

at a monitoring device, receiving from a photodetector a signal that conveys a characteristic of radiation received by the photodetector from an exit piece of a luminaire, through which exit piece light emitted by the luminaire exits the luminaire;

based on the characteristic, using the monitoring device to determine a dirt level on the exit piece;

outputting an indicator of the dirt level from the monitoring device;

identifying a geographic location associated with the luminaire based on a geographic proximity of the geographic location to the luminaire; and

in response to an increase in the indicated dirt level, cleaning an object at the geographic location that is separate from the luminaire.

The geographic location may be a geographic location other than that of the luminaire.

### BRIEF DESCRIPTION OF FIGURES

For a better understanding of the present invention and to show how the same may be carried into effect, reference is made by way of example to the following figures in which:

FIG. 1 shows a schematic block diagram of a lighting system;

FIGS. 2A and 2B show a luminaire having relatively lower and higher dirt levels respectively;

FIG. 3 shows an example of how dirt statuses can be assigned to luminaires based on reflectance and/transmittance;

FIG. 4 shows luminaries with assigned dirt statuses;

FIGS. 5A and 5B shows exemplary display states of a display device of a monitoring device.

### DETAIL DESCRIPTION OF EMBODIMENTS

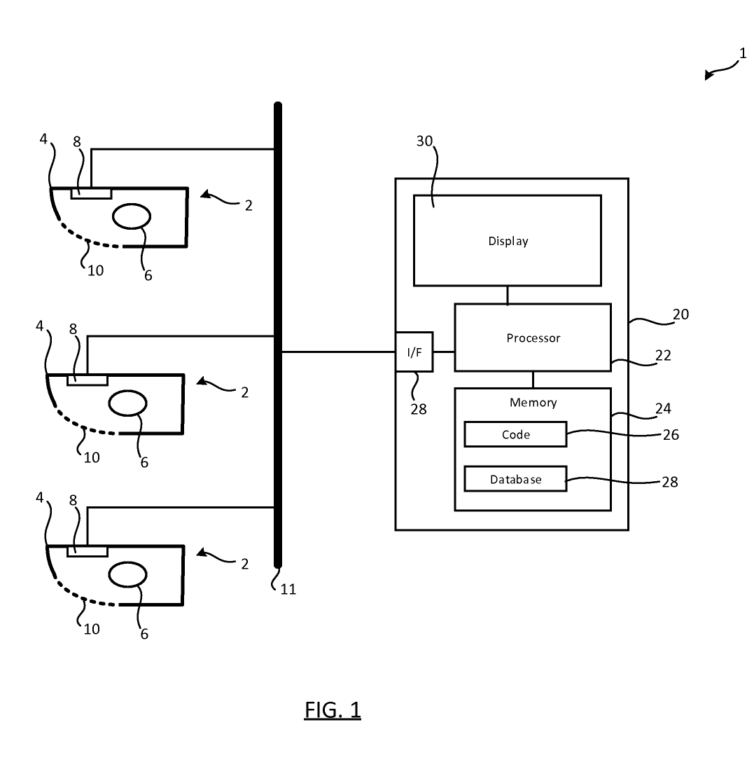

FIG. 1 shows a block diagram of an exemplary lighting system 1, which is an outdoor lighting system in this example. The outdoor lighting system 1 may be geographically distributed throughout a town or city (or part thereof), along a street (or part thereof), and/or within a complex of buildings etc. The system 1 comprises a plurality of luminaires 2, each comprising a respective casing 4, and a respective lamp 6 housed by the casing 4. The luminaires 2 may for example be outdoor luminaires supported by poles in the conventional manner. A part of the casing 4 is at least partially transparent and constitutes an exit piece 10 of the luminaire 2 (represented by a dotted line in FIG. 1) through which light emitted by the lamp 6 can exit the casing 4. The casing 4 is a closed casing i.e. it encloses the lamp 6. The lamp 6 is an LED lamp in the embodiments described herein, i.e. comprising one or more LEDs.

LED lighting is becoming more and more common in the outdoor domain. Besides the lower energy consumption LED lighting also offers a lifetime that is much longer than that of conventional lighting. This longer lifetime will also allow for longer intervals before maintenance is required. As outdoor LED light sources can last twenty years or more this means that the LED lighting infrastructure may not have any regular planned maintenance during this lifetime. This in turn means that cleaning of these luminaires is not (by default) planned for this period of time. Less cleaning would lead to less insight and more uncertainty on the ‘dirt-status’ of the lighting infrastructure. Moreover, if the LED lighting infrastructure is not cleaned throughout this period of time it might be the case that dirt levels are causing the lighting output to degrade considerably. This could lead to situations in which dirt levels become so high that regulatory requirements, or requirements from ‘service level agreements’ (SLAs) or ‘performance contracts’, are not met.

The issue is expected to become particularly significant in the context of managed services for outdoor lighting, i.e. whereby the lighting supplier is responsible for the lighting output.

In the embodiments described herein, the light output from luminaires serve as a measure of dirt. High (normal) light output accounts for clean luminaires whereas lower light output accounts for different levels of dirt. Measuring the light output of LED lighting fixtures provides valuable data that can be used to indicate when cleaning of specific luminaires is required.

As also shown in FIG. 1, each luminaire 2 also comprises a respective sensor 8, which is a photodetector. The sensor 8 is also housed in the casing 4, and thus enclosed by the casing 4 in the same manner as the lamp 6. The sensors 6 of the different luminaires are interconnected with one another so as to form a sensor network 11, for example a mesh network. In this context, a mesh network is one in which signals generated by the sensors 8 are transmitted through the network by the luminaires 2 acting as relays for other luminaires 2 rather than through dedicated routers, wireless access points etc. (though the possibility of using one or more of these dedicated network components as an alternative or in addition is not excluded). The network 11 may for instance be a ZigBee network. The network 11 may be built on wireless technology, wired technology or a combination of both.

The system 1 also comprises a remote monitoring device, which is a computer 20. The computer 20 comprises a network interface 28 via which the computer 20 is connected to the network 11. The computer 20 also comprises a memory 22, an output apparatus which comprises a display device (display) 30, and a processor 20 to which the memory 24, display 30 and network interface 28 are connected. The processor 20 can receive sensor data-bearing signals from each of the sensors 6 via the network 11. In this manner, information about dirt levels on the luminaires 2 is conveyed to the computer 20 through the network 11.

The memory 24 holds executable code, i.e. software, 26 for execution on the processor 20. When executed on the processor 22, the code 26 can process the received sensor data to perform various functions thereon that will be described in due course. These include determining a dirt status to each of the luminaires 2.

The memory 24 also holds a database 28 which is accessible to the code 26 when executed.

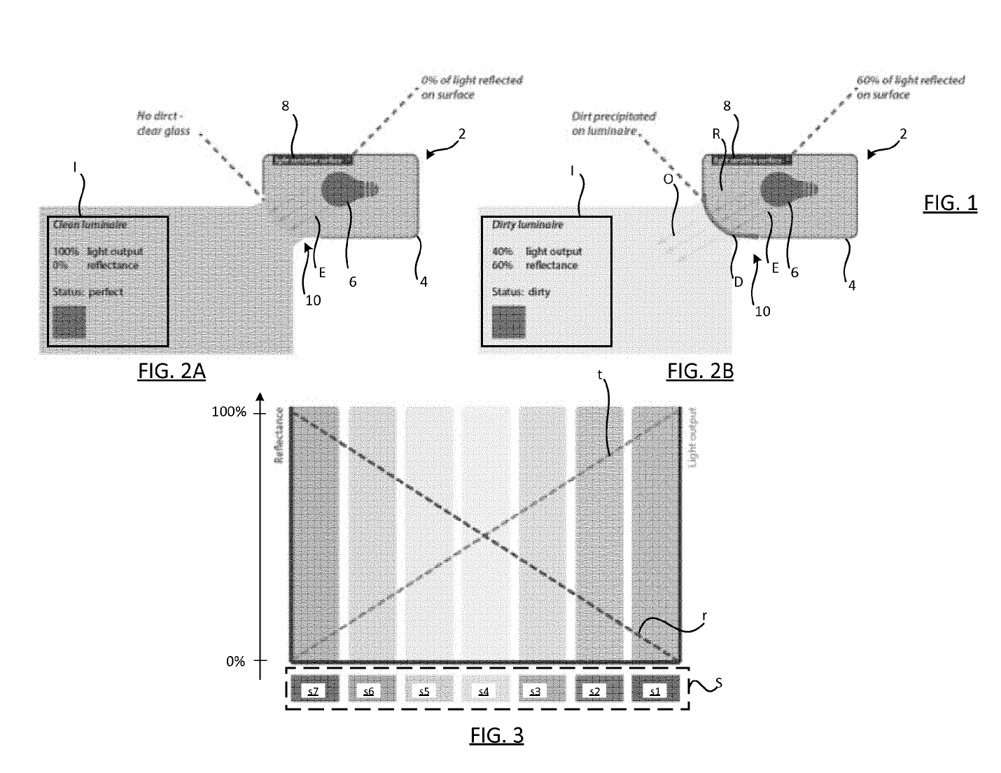

FIGS. 2A and 2B illustrates certain functions of such a luminaire 2. FIG. 2A illustrates an optimal dirt level scenario in which the exit piece 10 just been installed or cleaned, and it thus substantially free from any dirt. In contrast FIG. 2B illustrates a higher dirt level scenario, in which a layer of dirt D has built up on the exit piece 10.

Light E emitted by the lamp 6 is directed towards the exit piece 10, for example by internal optics of the luminaire 2 (not shown). The sensor 8 has a light sensitive surface and is located in the casing 4 so as to receive any parts of the emitted light E light reflected back from the exit piece 10 (R denotes such reflected light in the figures). The remaining parts (labelled O) are transmitted through the exit piece 10—the amount of light O that is transmitted is what determines the light output of the luminaire 2. Note herein E, O, R are also used to denote the respective power levels of the relevant light, as will be clear in context.

The exit piece 10 has a transmittance t which reduces over time as the dirt level on it increases as increasing amounts of dirt prevent more and more light from passing through the exit piece. To put it another way, the exit piece 10 has a reflectance r which increases over time as the dirt level increases as the increasing amounts of dirt cause more and more light to be reflected back from the exit piece 10. The reflectance r is the fraction of the power of incident light R that is reflected from the output piece, i.e. r=R/E. The transmittance is the fraction of the power of incident light O that is transmitted through the output piece, i.e. t=O/E—or to put it another the transmittance is the light output of the luminaire 2 expressed relative to the total power of the light E emitted by the lamp 6.

By measuring the amount of light R reflected by the dirt D on the luminaire an estimate can be made of a dirt level on the exit piece 10. A “dirt level” on an element mean a quantitative and/or qualitative measure of the amount of dirt on the element, and it can be defined and represented in a number of ways depending on the context. An increase in the dirt level means a change in the measure that conveys an increase in the amount of dirt.

For the ‘clear luminaire’ of FIG. 2A, no or negligible light is reflected and the light sensitive surface of the sensor 8 receives no or emitted light. When a layer of dirt D is precipitated on the transparent part 10 of the luminaire, this dirt D causes light to reflect inside the luminaire 2 from the exit piece 10 and to fall on the light sensitive surface of the sensor 8. As the amount of emitted light R that is reflected increases, the light output O will decrease as R+O=1.

Using the sensor 8, it is possible to measure the reflectance and/or the transmittance of the exit part 10. The reflectance/transmittance can for example be expressed as a fraction, percentage or decimal. A value of reflectance/transmittance can be determined by the luminaire 2 itself by internal processing components (not shown) and transmitted to the monitoring device 20 via the network 11, or it can be determined by the software 26 executed on the remote monitoring device 20 based on signals received from the sensor 10 via the network 11, such as ‘raw’, i.e. substantially unprocessed, sensor data received ‘correctly’ from the sensors.

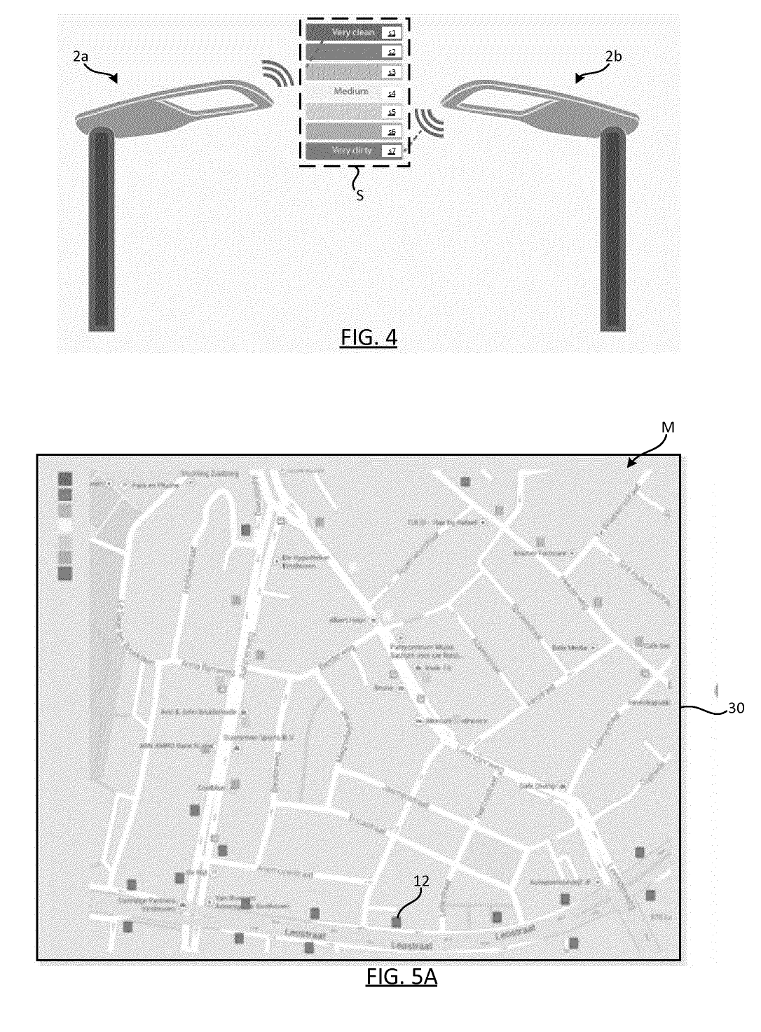

Dirt statuses are assigned to luminaires 2 by the software 26 these are based on a mapping from the levels of reflected light R, as shown in FIG. 3. FIG. 3 shows illustrates how the reflectance r and transmittance t are related as t+r=100% where r and t are expressed as percentages in this example.

In this example, each luminaire S is assigned a status from a discrete, finite set of statuses S={s1, . . . , s7}. There are seven possible statuses in the set S in this example, but in other cases there may be more or fewer possible statuses. Each of the individual statuses s1, . . . , s7 constitutes a discrete bin in the sense that a respective distinct and continuous subrange of values of the reflectance r and/or transmittance t are mapped to that status. Relatively lower reflectance subranges/higher transmittance subranges are mapper to ‘better’ statuses, i.e. indicating cleaner states, and relatively higher reflectance subranges/lower transmittance subranges are mapped to ‘worse’ statuses, i.e. indicating dirtier states. What subranges are suitable is context dependent, and setting them may involve a degree of manual tuning.

The individual statuses are represented by intuitive verbal descriptions of the dirt level on the applicable luminaire. A best state s1, to which the lowest reflectance subrange/highest transmittance subrange is assigned, may for example be ‘perfect’ or ‘very clean’—this is the status in the scenario of FIG. 2A. A reflected amount of around 60% may for example be assigned a status of ‘dirty’. Fort approaching 0%/r approaching 100%, a worst status s7, which may for example be ‘very dirty’ or ‘maximally dirty’, may be assigned. Alternatively or in addition the statuses may be represented visually by different colors, shades, tints, tones, shapes etc.

FIG. 4 shows a dirt indication for two individual outdoor lighting fixtures 2a, 2b representing the two extreme cases. The first (2a) has been assigned the best status s1, whereas the second (2b) has been assigned the worst status s7.

Alternatively or in addition, a binary measure may be assigned based on the reflectance r and/or transmittance t, wherein one value (denoted “0” for convenience) indicates that the luminaire does not need cleaning, and the other value (denoted “1” for convenience) indicates that the luminaire does need cleaning. In this case “0” is assigned when r is below/t is above a threshold and “1” when r is above/t is below the threshold. Note “0” and “1” can be represented in any suitable way, for example as intuitive verbal description—e.g. ‘clear’ or ‘OK’ for “0”, and ‘dirty’ or ‘cleaning required’ for “1”. In this manner, a luminaire can be ‘tagged’, based on the threshold, as requiring cleaning or not requiring cleaning. A suitable threshold at which a luminaire is ‘tagged’ as dirty will be dependent on the context and possibly the stakeholders. For some situations desired/required lighting levels are higher than for others. Setting the threshold may involve a degree of manual tuning.

Such binary measures and statuses constitute dirt levels, as do the reflectance r and transmittance tin their own right i.e. the latter can be viewed as a continuous, numerical definitions of the dirt level itself whereas the former are discrete, discontinuous definitions.

Data on dirt levels for individual luminaires are stored in the database 28; these data can be used for further analysis.

As indicated, the inventors have recognized that the information collected on dirt levels in this manner provides information not only about the luminaires themselves but also the dirt levels of their surroundings.

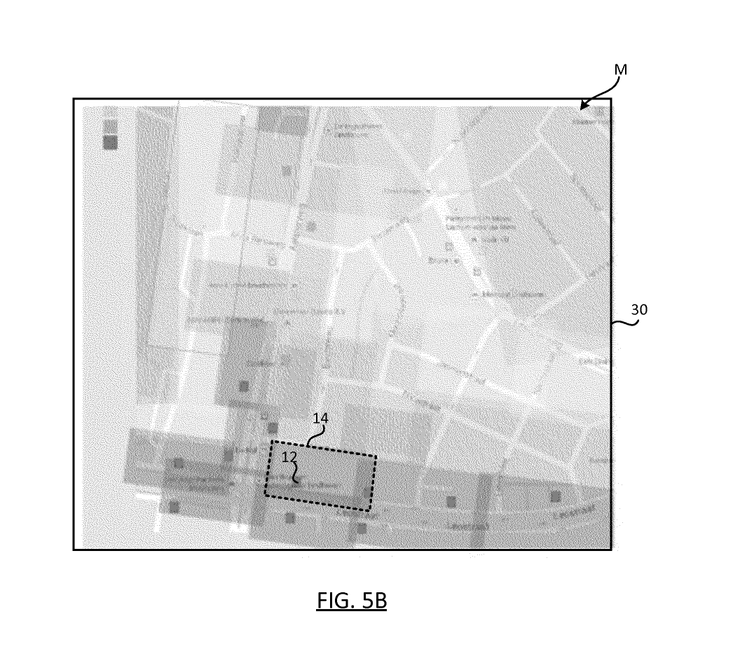

The following refers to FIGS. 5A and 5B, which represent exemplary states of the display 30 effected by the software 26, and in particular illustrate how various visual indicators 12, 14 may be generated by the software 26 and displayed on the display 30. Such indicators are used to identify geographic locations associated with a luminaire and/or objects at such locations.

When individual luminaires 2 are collecting data about their ‘dirt status’ the aggregated data set can also be used to get insight in the dirt status of specific parts of a street, area, neighborhood, or city etc. This is illustrated in FIG. 5A, which shows dirt status of individual luminaires or specific streets and areas.

FIG. 5A shows a map M of a region that encompasses multiple luminaires. Each of the luminaires 2 is represented by a respective visual indicator 12 (luminaire indicator).

A luminaire 12 performs two functions. Firstly, it indicates on the map M the (at least approximate) location of that luminaire. That is, it is overlaid on the map M at the location of the luminaire which it represents. Multiple luminaire indicators pertaining to multiple luminaires are outputted simultaneously. Secondly, the luminaire indicator 12 indicates the dirt status of the luminaire which it represents—for example this may be indicated by a color of the visual indicator, with each of the statuses s1, . . . , s7 being represented by a different color. The colors might change gradually from green through yellow and finally to red from best to worst status. Thus a luminaire indicator 12 is an indicator of both a location of the luminaire and of its dirt level.

Alternatively or additionally, the visual indicator may simply indicate whether or not cleaning is required—i.e. to indicate a binary value of the kind described. As an example, green and red indicators could indicate that cleaning is and is not required respectively.

What is more, if the individual dirt levels for the luminaires 2 are known, these data can be aggregated and analyzed in order to optimize maintenance/cleaning schedules of the lighting infrastructure. FIG. 5B shows an example of how this might be implemented. In this example, in addition to the visual indicators 12 indicating the locations and status of the luminaires (FIG. 5A), areas on the map M are delineated on the map by an additional visual indicator 14 (area indicator). Each area indicators 14 is associated with one or more luminaires and is the form of a colored shape (e.g. rectangle) which delineates that area in this example. Here, the color also indicates a dirt level for the specific area, based on the luminaire(s) associated with this area. This happens through aggregation of similar dirt levels of luminaires which also happen to be close together and in this way form an area that has a specific dirt level. Thus the area indicator 14 is also a dirt level indicator, as it the luminaire indicator 12.

Thus the association between the area and the luminaire(s) is based on a similarity in dirt level and geographic proximity of the area to the luminaire(s).

A process for automatically identifying such areas is described below.

Alternatively, the luminaire indicators 12 may be omitted so that only the area indicators 14 are shown. A (continuous) set of locations constitutes the area. The set comprises locations which are not that of the applicable luminaire (as indicated by the luminaire 12), and may or may not also include the location of the luminaire itself; that is, the area may or may not include one or more of the luminaire(s) with which it is associated.

Areas that are in urgent need of cleaning may for example be represented by red, whereas those represented by, say, green and yellow are not. Yellow indicates areas likely to require cleaning sooner than green areas.

These aggregated data on dirt-levels can also be used as a derivative to gain insight in dirt levels beyond the lighting infrastructure, regarding any object in the vicinity of a given luminaire, for instance regarding city furniture (e.g. park or other outdoor benches), buildings, and/or other city infrastructure.

There are a number of ways in which these data can be used; for example they can be used to offer all services such as:

Data to allow cleaning of lighting to make sure that output levels are compliant to regulations;

Data to allow cleaning lighting to prevent ugly/dirty appearance;

Data to schedule cleaning of city furniture;

Data to schedule cleaning of public or private buildings.

For 3 and 4, the data is being used to clean objects separate from the luminaire itself at geographic locations other than that of the luminaire itself but nonetheless associated with the luminaire i.e. at a different but nearby geographic location.

The terminology “a geographic location associated with the luminaire” means a geographic location that is in proximity to, i.e. the vicinity of, the luminaire, i.e. sufficiently near to the luminaire that the associate location has a dirt level which is correlated with that of the exit piece of the luminaire. That is, such that dirt, if left to its own devices, will accumulate on any object at that location at a rate that is predictable to a reasonable level of accuracy from the rate of accumulation of dirt on the exit piece of the luminaire. How near the object needs to be depends on a number of factors, such as environmental factors, obstruction by other nearby objects such as buildings. Such a location may for example be any location that is i) on the same road (e.g. street) as the luminaire and ii) within a certain radius of the luminaire (e.g. a radius of a few meters). The first condition of being on the same road is particularly applicable where the volume traffic on that road is a significant contributory factor to the overall dirt levels.

The location and/or the object may be identified automatically by the software 28, based on geographic proximity data held in the memory 24 that records information about location(s) and/or object(s) near to the luminaire. For example, the database 28 may also hold the locations of such objects, and also indicate them on the map M with suitable visual indicators (not shown). In addition, the object itself (and not just its location) may be identified. For example, the database may hold object identifiers identifying a type of the object, which may also be indicated on the map M—for example, a “bench” type object may be indicated by a bench graphic overlaid on the map at the (approximate) location of that bench. An object, or its surrounding area, may be tagged as requiring cleaning or not requiring cleaning based on a suitable threshold—but pertaining to that object rather than the luminaire—in the manner described above, and this may also be indicated on the map for example by a color, tint, shading, tone, shape etc. of the graphic—e.g. red and green bench graphics might represent benches that do and do not require cleaning, or a border may be introduced around the icon to denote cleaning is necessary etc.

As an alternative, the database 28 may hold for each luminaire a respective set of one or more object identifiers of objects that are associated with that luminaire. The software 26 may indicate the identity of the respective object(s) without identifying their specific locations, for example by outputting a list of such objects in association with an indicator of the bench.

Returning to FIG. 5B, given a set of multiple luminaires—for example some or all of the luminaires (to be) indicated on the map M, an exemplary mechanism for automatically determining areas of the kind indicated by reference sign 14 is as follows.

For at least one (e.g. each) of the set of multiple luminaires:

A difference between the dirt level of that luminaire and the dirt level of at least another luminaire is determined and, in turn, it is determined whether that difference exceeds a first amount. The first amount may be zero i.e. in which case this amounts to determining whether or not they have the same dirt level.

A geographic separation (e.g. Euclidian distance or other distance metric) between that luminaire and the other luminaire(s) is determined based on the geographic proximity data, which may, for example, indicate the geographic location of each luminaire as a respective coordinate pair. In turn, it is determined whether the geographic separation exceeds a second amount.

If (and only if) the difference does not exceed the first amount and the geographic separation does not exceed the second amount, that luminaires and the other luminaire(s) are treated as being associated (i.e. correlated) with one another. In this case, an area associated with the luminaire and the other luminaire(s) is determined, and indicated on the map in the manner discussed. The area may for example encompass and/or be within a certain radius of the luminaire and/or the other luminaire(s). The area may also have some dependence on the environment of that luminaire and the other luminaire(s)—for example, where the geographic proximity data indicates that those luminaires are within a certain distance of a building(s) and/or other obstacle(s) and/or road(s) etc., the area may be determines so that at least part of its edge is aligned with the building(s) and/or other obstacle(s) and/or road(s) etc.

Note the temporal ordering of steps S1 and S2 is immaterial. In some cases they may be interleaved in time or performed in parallel.

In certain embodiments, a dirt level indicator for the object itself may be computed based on that of the luminaire, but independent from the former in the sense that it is at least resettable independently of the dirt level on the luminaire i.e. whereby the dirt level on the object can be reset whilst the dirt level on the luminaire remains constant or increases, desirable to indicate that the object has been cleaned but the luminaire has not. The dirt level on the object may be reset after a to-be cleaned signal has been generated for the object by the monitoring device. Alternatively or additionally, different thresholds for the luminaire dirt level threshold may trigger cleaning of the object. For example, when the dirt level on the luminaire reaches e.g. 7, a signal may be generated, by the monitoring device, to clean the object(s) near the luminaire. A computer-stored dirt level increase counter may then be reset by the monitoring device and the next to be cleaned signal is then generated when the dirt level reaches 14 (or, say, a lower value if the dirt build up is not linear).

Whilst in the above the object separate from the luminaire is at a geographic location other than that of the luminaire, in other embodiment is may be at substantially the same location but nevertheless separate from the luminaire or any of the luminaire's supporting structure or components. For example, the object may be a bench underneath the luminaire. More generally, the object may be as substantially the same geographic location as the luminaire but have a different elevation and/or height than the luminaire (e.g. and a luminaire may be elevated e.g. 6-12 meters above the ground, whereas the object may be a bench at ground level having a height of about 1.5-2.5 meters, or a building significantly higher or lower than the luminaire).

Alternatively the identification of such a location and/or such an object may be manual in some cases. For example a cleaner or cleaning team may travel along a road when the dirt levels, as measured using luminaires distributed along that road, reach a certain level, looking out for nearby objects that need cleaning.

The point at which an object required cleaning may or may not also be the point at which the luminaire requires cleaning. For example, when a luminaire 2 gets to dirt level corresponding to, say, reflectance r= 1/10, the park bench nearby may need to be cleaned, even though the luminaire 2 may not need cleaning yet. Therefore when it is centrally administered that the park bench has been cleaned, a ‘clean park bench’ conclusion is next drawn on the basis of the dirt level of the luminaire reaching, say, r= 2/10.

When an object has been cleaned, the database 28 may be updated to reflect that fact. For example, a cleaning time may be stored in association with an object identified and updated to reflect the latest cleaning time. The software 26 can then notify a user next time cleaning is needed based on both the most recent cleaning time and the dirt level of the nearby luminaire.

The time at which cleaning of an object is triggered may depend on an characteristic(s) of the object and/or its environment. That is, an aspect of the object and/or the area surrounding the luminaire could be taken into account: for example, a dirt level of X could trigger a bench to be cleaned (as people generally will not want to sit on a dirty bench), yet only when it reaches level Y does it trigger the sidewalk to be hosed down (as people are generally less concerned about this). Thus cleaning of an object may be triggered based on a computer-stored information about that object, identifying a characteristic of the object and/or its environment, for example the generation of the control signal that triggers the cleaning may be timed based on the accessed information.

An object separate, i.e. distinct, from the luminaire means an object that is disconnected from the luminaire i.e. that does not form part of and is not mounted on the luminaire. Where the luminaire is supported by a stricture such as a pole, the object is also disconnected (in the same sense) from the supporting structure. The object may be unrelated in function to the luminaire, and unlike the luminaire may be non-electrical, i.e. not connected an artificial electrical source, for example if it is a piece of furniture or an outer wall of a building. The term “luminaire” includes all functional components relating to the illumination function, including the lamp and any additional electrical components which enable the lamp to provide the desired illumination such as transformers, circuitry, safety mechanisms etc.; the casing (including the exit piece); and any supporting components such as a frame, mount, suspension etc.

Whilst in the above the light emitted from the lamp 6 itself is used to monitor dirt levels, the possibility of using a separate radiation source (visible or non-visible e.g. infrared) to this end is not excluded. Further whilst in the above the characteristic of the detected radiation is its power level, other characteristics (such as frequency, spatial distribution etc.) can also provide information about the dirt level.

Outputting an indicator means to a user of the monitoring device 20. The above considers visual indicators, but the possibility of outputting non-visual indicators (e.g. audible indicators) as alternative or in addition is not excluded. An outputted “set of associated indicator(s)” means that, where there are multiple indicator(s) in the set, they are outputted in association with one another i.e. in a manner that a conceptual link between them is evident to a user. For example, they may be outputted at substantially the same time, and/or in proximity to one another on a display (for visual indicators) and/or information explicitly describing this link may also be outputted.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with, or as part of other hardware, but may also be distributed in other forms, such as via the Internet or other wired or wireless telecommunication systems. Any reference signs in the claims should not be construed as limiting the scope.

1. A method comprising:
at a monitoring device, receiving from a photodetector a signal that conveys a characteristic of radiation received by the photodetector from an exit piece of a luminaire, through which exit piece light emitted by the luminaire (E) exits the luminaire;
based on the characteristic, using the monitoring device to determine a dirt level on the exit piece;
accessing geographic proximity data pertaining to the luminaire in computer storage;
using the accessed data to automatically identify at least one geographic location associated with the luminaire, other than that of the luminaire, and/or an object separate from the luminaire; and
in response to an increase in the determined dirt level, the monitoring device generating a control signal, the control signal comprising a set of one or more indicators indicating the dirt level and the at least one location and/or the object,
wherein the control signal triggers a process causing an object at the geographic location and/or the object to be cleaned.

2. A method according to claim 1 wherein the object is a piece of furniture or a building, and/or a piece of city infrastructure.

3. A method according to claim 1 wherein at least the exit piece is also cleaned in response to said increase.

4. A method according to claim 1 wherein the exit piece of the luminaire is not cleaned in response to said increase, and the method also comprises:
in response to an a further increase in the indicated dirt level, cleaning: the object again and/or another such object at another such location and/or at least the exit piece of the luminaire.

5. A method according to claim 1 wherein the control signal is generated in response to the monitoring device detecting that the dirt level on the luminaire has reached a first threshold, and the method also comprises:
in response to the monitoring device detecting that the dirt level on the luminaire has subsequently reached a second threshold higher than the first threshold, the monitoring device generating another control signal which causes the object to be cleaned again.

6. A method according to claim 1, wherein the accessed data is used to identify at least the object separate from the luminaire, comprising the monitoring device:
computing a dirt level on the object based on the dirt level on the luminaire; and
in response to the increase in the determined dirt level on the luminaire, increasing the computed dirt level on the object;
wherein the control signal causes the monitoring device to: output an indicator of the increased dirt level on the object so as to cause said cleaning, and then reset the computed dirt level on the object without resetting the dirt level on the luminaire.

7. A method according to claim 1 comprising the monitoring device accessing in computer storage information about the object, the information describing at least one characteristic of the object and/or its environment, wherein the control signal is generated based on the accessed information.

8. A method according to claim 1 wherein the characteristic conveyed by the signal is a power level of the radiation.

9. A method according to claim 1 comprising outputting an indicator of the dirt level from the monitoring device, the control signal causing the indicator to convey the increase in the dirt level.

10. A method according to claim 1 wherein the indicator of the dirt level comprises a reflectance and/or a transmittance of the exit piece and/or a verbal description of the dirt level.

11. A computer program product comprising code stored on a computer readable storage medium and configured when executed to perform operations of:
receiving from a photodetector a signal that conveys a characteristic of radiation received by the photodetector from an exit piece of a luminaire, through which exit piece light emitted by the luminaire exits the luminaire;
based on the characteristic, determining a dirt level on the exit piece;
accessing geographic proximity data pertaining to the luminaire in computer storage;
using the accessed data to identify at least one geographic location associated with the luminaire, other than that of the luminaire, and/or an object separate from the luminaire; and
outputting a set of one or more indicators, the outputted set indicating the dirt level and the at least one location and/or the object.

12. A computer program product according to claim 11 wherein the set comprises a visual indicator that is outputted on a map via a display device and indicates the at least one location on the map.

13. A computer program product according to claim 12 wherein the at least one location is one of a set of locations that constitutes an area, and the visual indicator delineates the area on the map.

14. A computer program product according to claim 12 wherein the luminaire is one of multiple luminaires, wherein for each luminaire a respective signal is received from a respective photodetector, wherein the respective signal conveys a respective characteristic of radiation received by the respective photodetector from an exit piece of that luminaire, wherein a respective dirt level is determined on the exit piece of each luminaires, wherein the operations comprises:
for at least another of the luminaires:
determining a difference between the dirt level of said luminaire and the dirt level of the other luminaire;
determining whether the difference exceeds a first amount;
determining a geographic separation between the luminaire and the other luminaire based on the geographic proximity data;
determining whether the geographic separation exceeds a second amount; and
if the difference does not exceed the first amount and the geographic separation does not exceed the second amount: determining an area associated with the luminaire and the other luminaire, the area including the at least one geographic location, and indicating the area on the displayed map.

15. A monitoring device comprising:
an output apparatus;
an input configured to receive from a photodetector a signal that conveys a characteristic of radiation received by the photodetector from an exit piece of a luminaire, through which exit piece light emitted by the luminaire exits the luminaire;
a processor configured to perform operations of:
based on the characteristic, determining a dirt level on the exit piece;
accessing geographic proximity data pertaining to the luminaire in computer storage;
using the accessed data to identify at least one geographic location associated with the luminaire, other than that of the luminaire, and/or an object separate from the luminaire; and
outputting a set of one or more indicators, the outputted set indicating the dirt level and the at least one geographic location and/or the object.
